(19) United States
(12) Patent Application Publication
(10) Pub. No.: US 2023/0342741 A1
(43) Pub. Date: Oct. 26, 2023

(54) ASSET RIGHT MANAGEMENT SYSTEM BASED ON BLOCKCHAIN AND METHOD THEREOF

(71) Applicant: Skychain CO., LTD., Taipei City (TW)

(72) Inventors: Chen-Hsuan WANG, Taipei City (TW); Jiann-Min YANG, Taipei City (TW); Scott MIAU, Taipei City (TW)

(21) Appl. No.: 18/215,844

(22) Filed: Jun. 29, 2023

Related U.S. Application Data
(63) Continuation-in-part of application No. 17/065,584, filed on Oct. 8, 2020.

(30) Foreign Application Priority Data
Oct. 30, 2019 (TW) 108139281

(51) Int. Cl. G06Q 20/12; G06Q 20/38; G06Q 20/36

(52) U.S. Cl. CPC G06Q 20/1235; G06Q 20/389; G06Q 20/36; G06Q 2220/10

(57) ABSTRACT

An asset right management system based on blockchain and a method thereof are disclosed. In the system, an asset smart contract of the asset is pre-deployed on a blockchain network, and an asset smart contract is executed to generate a fungible ownership token representing the ownership of the asset, and generate a non-fungible use-right token representing the right to use the asset, based on the ownership token; when the asset smart contract receives proceeds which is obtained through a transaction of the use-right token, the asset smart contract calculates and transfers an profit-sharing amount of each owner, so as to achieve the technical effect of improving convenience in rights management and income of the asset.

### CROSS-REFERENCE STATEMENT

This application is a continuation-in-part of U.S. patent application Ser. No. 17/065,584, filed Oct. 8, 2020, which is based on, and claims priority from TAIWAN Patent Application Serial Number 108139281 filed on Oct. 30, 2019, the disclosure of which are hereby incorporated by reference herein in their entirety.

### BACKGROUND

### Technical Field

The present invention relates to a right management system and a method thereof, and more particularly to an asset right management system based on blockchain and a method thereof.

### Description of the Related Art

In recent years, with the popularization and rapid development of e-commerce, various related applications have sprung up, and the token executed in a blockchain network is the most common application.

In general, an issuer of a token can sell the token to other users, and the user can use the service provided by the issuer based on the purchased token. At the beginning, various tokens are substantially similar, but different in the number only, and this type of tokens can be called a fungible or replaceable token and suitable for interchangeable assets, such as points or cash. However, the fungible token is not suitable for non-interchangeable assets, such as real estate or a collection, because these assets are unique and irreplaceable assets.

For this reason, some manufacturers have proposed non-fungible token technical solution. Each non-fungible token has a unique identification code and is permitted to have different attributes. Therefore, the non-fungible token can be applied to non-interchangeable assets. However, both of the fungible token and non-fungible token regard the ownership and use rights of assets as the same, and do not clearly distinguish between the use right and the ownership of the asset, so it is impossible to separately manage or transact the ownership or the use right of the asset by using the convention token. There are problems of inconvenience in asset rights management and income.

In summary, what is needed is to develop an improved technical solution to solve the conventional technical problem of inconvenience in rights management and income of the asset.

### SUMMARY

An objective of the present invention is to provide an asset right management system based on blockchain and a method thereof, to solve the conventional problems.

In order to achieve the objective, the present invention provides an asset right management system based on blockchain, and the asset right management system is applied to the blockchain network which is formed by a plurality of node hosts, each of the node hosts has a wallet address as node identification and has the ability to access a blockchain wallet according to the wallet address; the asset right management system includes an ownership issuing host and a use-right issuing host. The ownership issuing host is one of the plurality of node hosts and includes a first computer readable storage device and a first hardware processor. The first computer readable storage device configured to store a plurality of first computer instructions, and the first hardware processor coupled to the first computer readable storage device, the first hardware processor configured to execute the first computer instructions to pre-deploy an asset smart contract of an asset in a blockchain network in initial, and the asset smart contract comprises at least one owner account and ownership-ratio information corresponding to the at least one owner account, and to execute a token generating function of the asset smart contract; the token generating function generates at least one fungible ownership token based on the ownership-ratio information. The use-right issuing host is one of the plurality of node hosts, stores one of the at least one owner account, and includes a second computer readable storage device and a second hardware processor. The second computer readable storage device configured to store a plurality of second computer instructions, the second hardware processor coupled to the second computer readable storage device, the second hardware processor configured to execute the second computer instructions to execute a use-right issuing function of the asset smart contract, and the use-right issuing function transmits a use-right issuing request to request an owner to approve issue of a right to use the asset, and to perform the use-right issuing function after the use-right issuing request is approved to generate at least one non-fungible use-right token based on the ownership token and permit to set a use-right transfer condition of the at least one use-right token, and request the owner to approve the use-right transfer condition; the use-right token comprises user information, and to permit the asset smart contract to receive digital currency as proceeds after the use-right transfer condition is approved, and to transfer the use-right token from the asset smart contract to a buyer account and to set the user information to the buyer account, and to calculate a profit-sharing amount of each of the at least one owner account based on the proceeds and the ownership-ratio information, and transfer the digital currency, which are equivalent to all of the at least one profit-sharing amount, to the at least one owner account, respectively.

Furthermore, the present invention provides an asset right management method based on blockchain, and the asset right management method is applied to a blockchain network which is formed by a plurality of node hosts, each of the node hosts has a wallet address as node identification and has the ability to access a blockchain wallet according to the wallet address; the asset right management method includes the steps of: pre-deploying, by an ownership issuing host which is one of the plurality of node hosts, an asset smart contract of an asset in the blockchain network, wherein the asset smart contract comprises at least one owner account and ownership-ratio information corresponding to the at least one owner account; executing, by the ownership issuing host, a token generating function of the asset smart contract, to generate at least one fungible ownership token based on the ownership-ratio information; using one of the plurality of node hosts which stores one of the at least one owner account, as a use-right issuing host, wherein when the use-right issuing host executes a use-right issuing function of the asset smart contract, and the use-right issuing function transmits a use-right issuing requests to request at least one owner to approve the issue of right to use the asset; after approval of the use-right issuing request is obtained, performing a use-right issuing function to generate the at least one non-fungible use-right token based on the ownership token, permitting to set a use-right transfer condition of the use-right token, and requesting the at least one owner to approve the use-right transfer condition, wherein the use-right token comprises user information; when an approval of setting the use-right transfer condition is obtained, permitting the asset smart contract to receive digital currency as proceeds, and the asset smart contract to transfer the use-right token to a buyer account from the asset smart contract and to set the user information to the buyer account; calculating a profit-sharing amount of each of the at least one owner account based on the proceeds and the ownership-ratio information, and transferring the digital currency equivalent to all of the at least one profit-sharing amount, to the at least one owner account, respectively.

According to above-mentioned system and method of the present invention, the difference between the present invention and the conventional technology is that in the system and method of the present invention the asset smart contract of the asset is pre-deployed in the blockchain network, and the asset smart contract is executed to generate the fungible ownership token representing the ownership of the asset, and generate the non-fungible use-right token representing the right to use the asset, based on an ownership token, and when the asset smart contract receives the proceeds obtained through the transaction of the use-right token, the profit-sharing amount is calculated and transferred to each owner.

The aforementioned technical solution of the present invention can achieve technical effect of improving convenience in rights management and income of the asset.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of an asset right management system based on blockchain, according to the present invention.

FIGS. 2A-2C are flowcharts of an asset right management method based on blockchain, according to the present invention.

FIGS. 3A and 3B are schematic views of right management system of the present invention applied to artwork, software, real estate and vehicle.

FIG. 4 is a schematic view of a transaction of an ownership token and a use-right token of the present invention.

### DETAILED DESCRIPTION

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

The terms defined in the present invention are described before the description of the asset right management system based on blockchain and method thereof of the present invention. The term “asset smart contract” of the present invention means the smart contract deployed in the blockchain network. In fact, the smart contract means a computer program for driving execution commands based on a predetermined condition and transferred information, and particularly, the smart contract is programmed with programming language, such as Solidity, Serpent, LLL, EtherScript, or Sidechain, and the smart contract can include different functions, events and parameter states; for example, in Ethereum environment, a smart contract is compiled to obtain binary codes and an application binary interface (ABI), so as to broadcast the smart contract to the blockchain network and wait for a miner or a validator to deploy the smart contract in the blockchain to obtain a corresponding address, which is also called a contract address; so far the smart contract is completely deployed through the blockchain transaction. The term “pre-deploy” refers to the technical means deployed on the blockchain at the beginning. In other words, the technical means of “pre-deploy” is the same as the commonly known “deploy” in that it involves sending a smart contract to the blockchain network, allocating a unique record for the contract, and enabling the storage and execution of the smart contract program by nodes in the blockchain network. The only difference is in the timing of deployment. Next, each node host can execute the smart contract based on the corresponding address, and change a state of the smart contract in the blockchain by different command and detect whether an event is triggered. Furthermore, the term “registry” means executing the function of the smart contract to store an address of another smart contract into the smart contract, for example, the address of another smart contract is stored in an array; that is, the smart contract is registered in another smart contract, so that the two smart contracts are associated with each other.

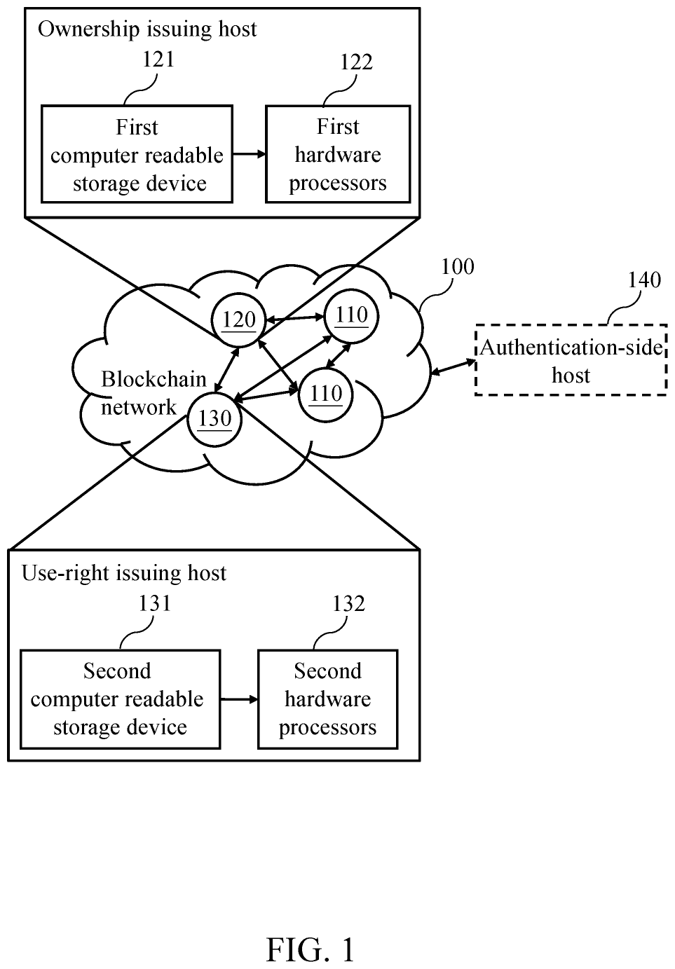

The asset right management system and the method thereof of the present invention are hereinafter described in more detail with reference to the accompanying drawings. Please refer to FIG. 1, which is a system block diagram of an asset right management system based on blockchain, according to the present invention. The asset right management system is applied to a blockchain network 100 formed by a plurality of node hosts 110, each of the node hosts 110 has a wallet address as node identification and has the ability to access a blockchain wallet according to the wallet address, for example, blockchain network 100 can be a Bitcoin or Ethereum network. The system includes an ownership issuing host 120 and a use-right issuing host 130. In actual implementation, each of the node hosts 110 can be a computer device with a network function, for example, the node host 110 can be a personal computer, a notebook computer, or a server. Furthermore, the blockchain network 100 can include a bitcoin blockchain network, an Ethereum blockchain network, or other similar blockchain network. Furthermore, the node hosts 110 communicate with each other in peer to peer (P2P) connection.

The ownership issuing host 120 is one of the plurality of node hosts 110 and includes a first computer readable storage device 121 and a first hardware processor 122. In initial, the first computer readable storage device 121 configured to store a plurality of first computer instructions. The first hardware processor 122 coupled to the first computer readable storage device 121 and configured to execute the first computer instructions, so that the first hardware processor 122 pre-deploys an asset smart contract of an asset in the blockchain network 100, the asset smart contract includes an owner account and ownership-ratio information corresponding to the owner account. In actual implementation, according to different functions, such as management of ownership, management of use right, right transfer, and so on, the asset smart contract can be implemented by different smart contracts which are bound with each other (for example, the address of the smart contract is registered to another smart contract), and one of the smart contracts can call a function of another of the smart contracts to interact.

The first hardware processor 122 configured to execute a token generating function of the asset smart contract; the token generating function can generate at least one corresponding and fungible ownership token based on the ownership-ratio information. In actual implementation, when the blockchain network 100 is based on an Ethereum blockchain architecture, the generation of the ownership token can be implemented by ERC20 standard. Furthermore, the ownership token can be transacted and transferred to other person (such as a buyer or other owner) through the blockchain; that is, the ownership token represents the ownership of the asset and can be transferred through the blockchain transaction. It is to be particularly noted that the token generating function can detect whether a generation condition has been satisfied already before the token generating function generates the ownership token, and the detection may be regarded as the verification of the validity of the ownership; when the generation condition is satisfied, the ownership token is permitted to generate; otherwise, the ownership token is not permitted to generate. In an embodiment, the generation condition includes approval of more than half of the asset owners and the approval of the authority related to the asset.

The use-right issuing host 130 is also one of the plurality of node hosts 110, and stores one of the at least one owner account. The use-right issuing host 130 includes a second computer readable storage device 131 and a second hardware processor 132. The second computer readable storage device 131 configured to store a plurality of second computer instructions. The second hardware processor 132 coupled to the second computer readable storage device 131 and configured to execute the second computer instructions. The second hardware processor 132 is configured to execute a use-right issuing function of the asset smart contract, to make the use-right issuing function transmit a use-right issuing request to request the at least one owner to approve the issue of the right to use the asset. The right to use the asset is also called the use right of the asset herein. In actual implementation, the way of transmitting the use-right issuing request can include transmission of the use-right issuing request to all of the at least one owner account or/and to a preset attorney account to request approval of issuing the right to use the asset. Furthermore, the condition of obtaining approval of the use-right issuing request can include that the amount of owner accounts approving to issue the use right satisfies a threshold value; for example, when the threshold value is set as 51%, it represents disapproval when the amount (or percentage) of owner accounts approving to issue the use right is lower than 51%, and it represents approval when the amount of owner accounts approve to issue the use right is higher than 51%. Besides the determination based on the threshold value, the use-right issuing request can be regarded as being approved after receipt of the approval information transmitted from the attorney account. The attorney account can be preset in the asset smart contract.

After approval of the use-right issuing request is obtained, the second hardware processor 132 can execute a use-right issuing function to generate a corresponding and non-fungible use-right token (a non-fungible token) based on the ownership token, and permit to set a use-right transfer condition of the use-right token, and request the owner to approve the use-right transfer condition. The use-right token includes user information. In actual implementation, the use-right token can be implemented by ERC721 standard, that is, the use-right token executed in the blockchain network 100 can be created by the smart contract. It is to be particularly noted that, similar to the ownership token, the use-right token can be transacted and transferred to other person through the blockchain, and the difference between the use-right token and the ownership token is that the use-right token is unable to be divided but the ownership token is able to be divided. In fact, the transfer of the use-right token represents the transfer of the right to use the asset.

After the owner approves to set the use-right transfer condition, the second hardware processor 132 can permit the asset smart contract to receive the digital currency as proceeds, and transfer the use-right token from the asset smart contract to a buyer account, and set the user information to the buyer account. In actual implementation, in initial, the user information can be set as the address of the asset smart contract, and when the use right is first transferred, the usage information is changed from the address of the asset smart contract to the buyer account. In an embodiment, the address and the account are generated by hashing and encoding, for example, SHA-256 and RIPEMD-160 can be used for hashing, and the Base58Check is used for encoding. Actually, the term “transfer” refers to the technical means of reducing the balance of one wallet address while increasing the balance of another wallet address, defined in Ethereum, ERC20, ERC1155 and hyperledger, or changing the ownership registration to another wallet address, defined in ERC721 and hyperledger. The transfer of ownership is implemented by changing the registered owner. For fungible assets, it involves reducing the balance of one wallet address while increasing the balance of another wallet address (i.e. fungible ownership token). For non-fungible assets, it entails changing the ownership registration to another wallet address. Additionally, setting the user information to the buyer account can be achieved directly by configuring or modifying the parameter values or array contents of the asset smart contract.

The second hardware processor 132 configured to calculate a profit-sharing amount of each of the at least one owner account based on the proceeds and the ownership-ratio information, and transfer the digital currency, equivalent to the profit-sharing amount, to the at least one owner account, respectively. For example, it is assumed that the digital currencies equivalent to the profit-sharing amount is 100 ETH, and the ownership ratio of one of the at least one owner account recorded in the ownership-ratio information is 2/100, so the second hardware processor 132 transmits 2 ETH to the one of the at least one owner account. Furthermore, the amount of the ownership token held by each of the owners also represent the ownership-ratio information, so the second hardware processor 132 can directly calculate the profit-sharing amount and share profile based on the amount of the ownership tokens held by the owners, so as to achieve the purpose of sharing profit based on the ownership.

Furthermore, the asset right management system of the present invention can include an authentication-side host 140 configured to receive identity information and detect whether the identity information exists in the user information of the use-right token, and if the identity information exists in the user information of the use-right token, the authentication-side host 140 permits the asset to be used or accessed; otherwise, the authentication-side host 140 prohibits the asset from being used or accessed. In actual implementation, the identity information and the user information can be hashed by SHA-256 and RIPEMD-160, and the string encoded by Base58Check such as “0x06012c . . . ” can also be called an address or an account.

It is to be particularly noted that, in actual implementation, the present invention can be implemented fully or partly based on hardware, for example, the hardware processor of the system can be implemented by integrated circuit chip, system on chip (SoC), a complex programmable logic device (CPLD), or a field programmable gate array (FPGA). The concept of the present invention can be implemented by a system, a method and/or a computer program. The computer program can include computer-readable storage medium which records computer readable program instructions, and the hardware processor can execute the computer readable program instructions to implement concepts of the present invention. The computer-readable storage medium can be a tangible apparatus for holding and storing the instructions executable of an instruction executing apparatus Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, a RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as electric signal transmitted through electric wire), or optical signal transmitted through fiber cable). Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

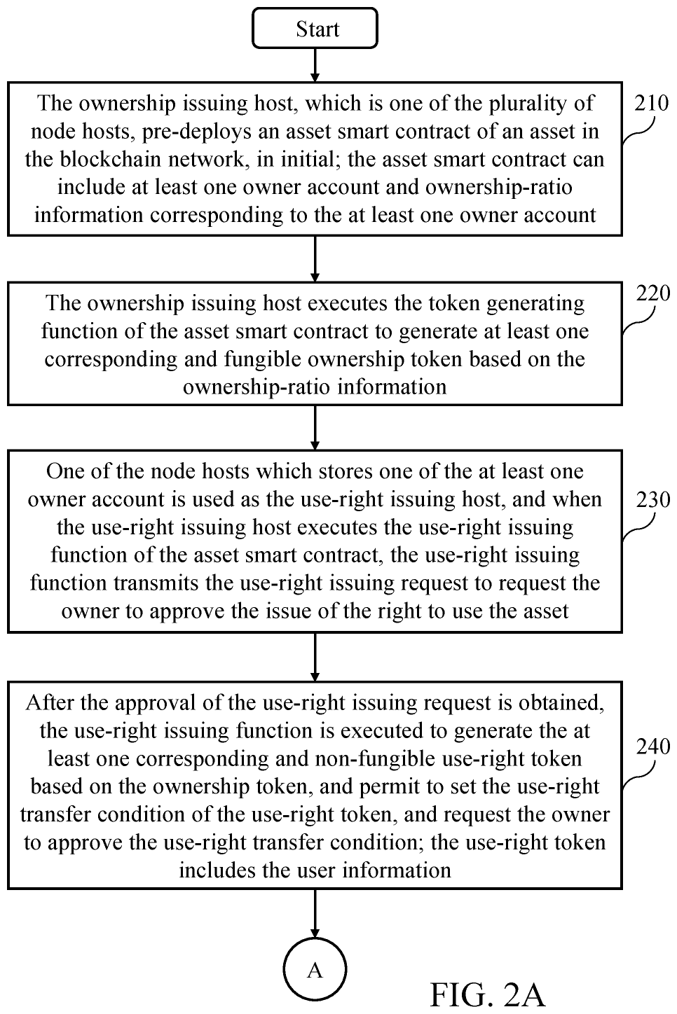

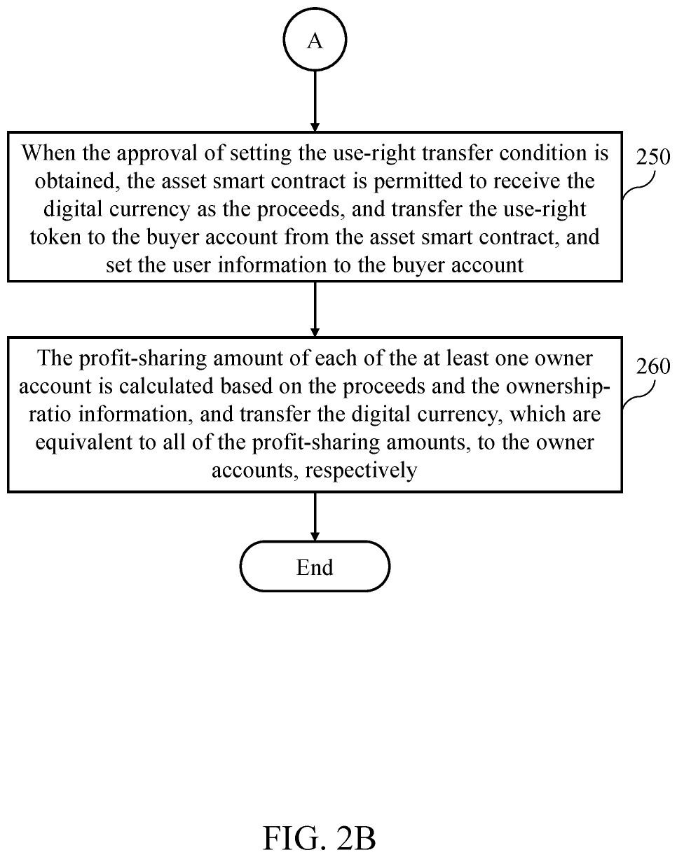

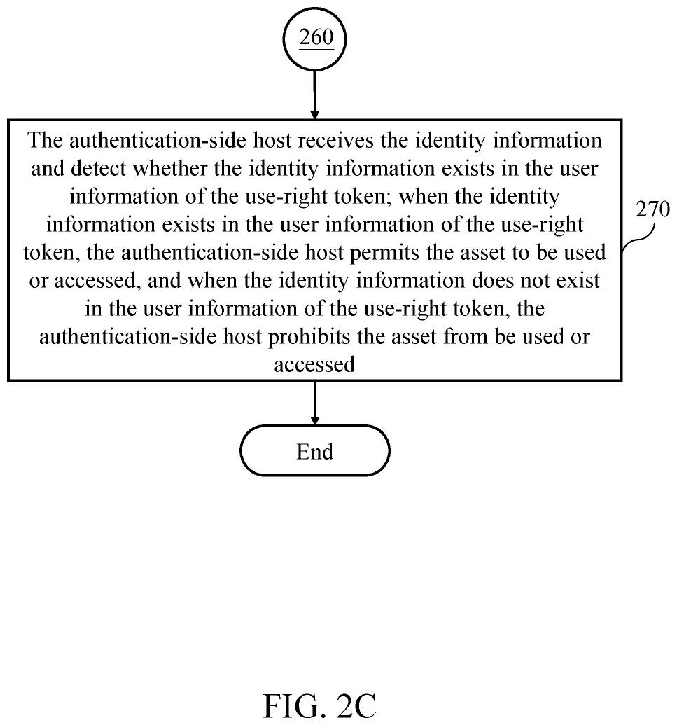

Please refer to FIGS. 2A-2C, which are flowcharts of an asset right management method based on blockchain, according to the present invention. The asset right management method can be applied to the blockchain network 100 formed by the plurality of node hosts 110. As shown in FIGS. 2A-2C, the asset right management method includes following steps. In a step 210, the ownership issuing host 120, which is one of the plurality of node hosts 110, pre-deploys an asset smart contract of an asset in the blockchain network 100, in initial; the asset smart contract can include at least one owner account and ownership-ratio information corresponding to the at least one owner account. In a step 220, the ownership issuing host 120 executes the token generating function of the asset smart contract to generate at least one corresponding and fungible ownership token based on the ownership-ratio information. In a step 230, one of the node hosts 110 which stores one of the at least one owner account is used as the use-right issuing host 130, and when the use-right issuing host 130 executes the use-right issuing function of the asset smart contract, the use-right issuing function transmits the use-right issuing request to request the owner to approve the issue of the right to use the asset. In a step 240, after the approval of the use-right issuing request is obtained, the use-right issuing function is executed to generate the at least one corresponding and non-fungible use-right token based on the ownership token, and permit to set the use-right transfer condition of the use-right token, and request the owner to approve the use-right transfer condition; the use-right token includes the user information. In a step 250, when the approval of setting the use-right transfer condition is obtained, the asset smart contract is permitted to receive the digital currency as the proceeds, and transfer the use-right token to the buyer account from the asset smart contract, and set the user information to the buyer account. In a step 260, the profit-sharing amount of each of the at least one owner account is calculated based on the proceeds and the ownership-ratio information, and transfer the digital currency, which are equivalent to all of the profit-sharing amounts, to the owner accounts, respectively. Through aforementioned steps, the asset smart contract of the asset can be pre-deployed on the blockchain network, and the asset smart contract is executed to generate the fungible ownership token representing the ownership of the asset, and also generate the non-fungible use-right token representing the right to use the asset, based on the ownership token, so that when the asset smart contract receives the proceeds obtained through the transaction of the use-right token, the asset smart contract can transfer the use-right token, and calculate and transfer the profit-sharing amount to the owner.

Furthermore, after the step 260, the asset right management method can further include a step 270 in which the authentication-side host 140 receives the identity information and detect whether the identity information exists in the user information of the use-right token; when the identity information exists in the user information of the use-right token, the authentication-side host 140 permits the asset to be used or accessed, and when the identity information does not exist in the user information of the use-right token, the authentication-side host 140 prohibits the asset from be used or accessed. In other words, the authentication-side host 140 can authenticate a user's identity, when the user information of the use-right token matches the user's identity, it represents that the user owns the right to use the asset, so the user is permitted to use the asset; otherwise, the user is prohibited from using the asset. The exemplary illustration will be described with reference to the accompanying drawings.

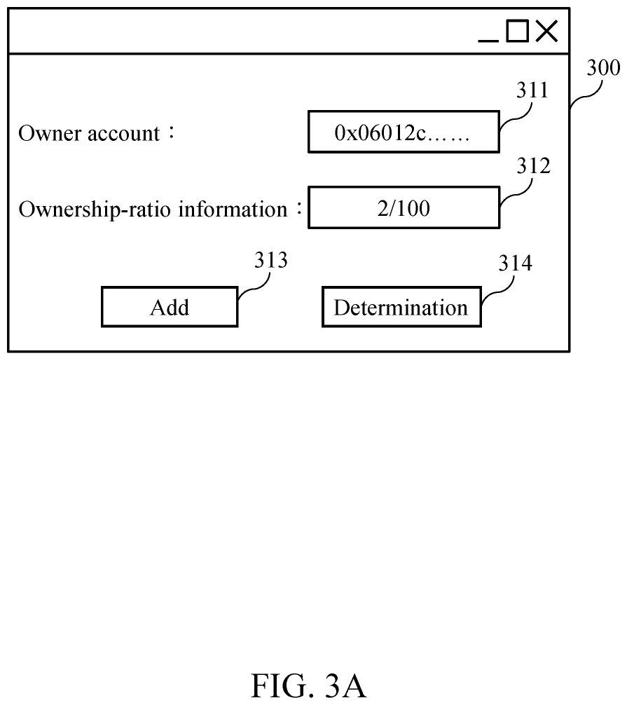

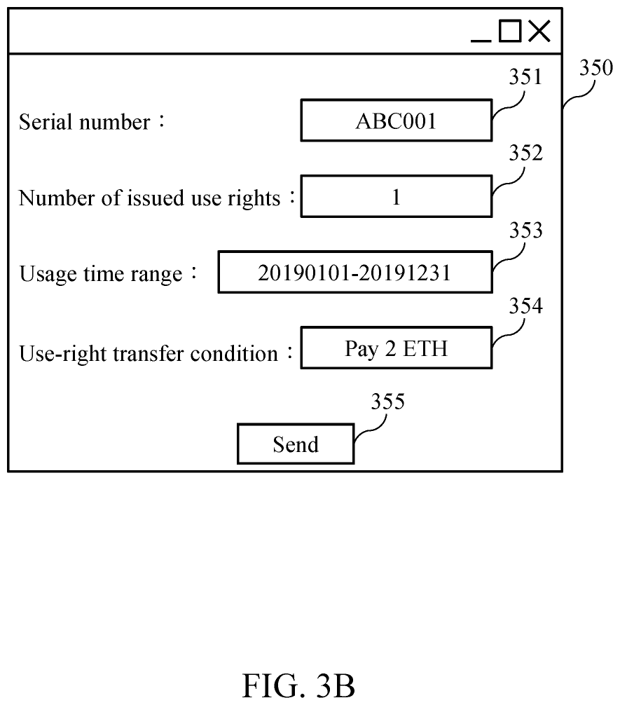

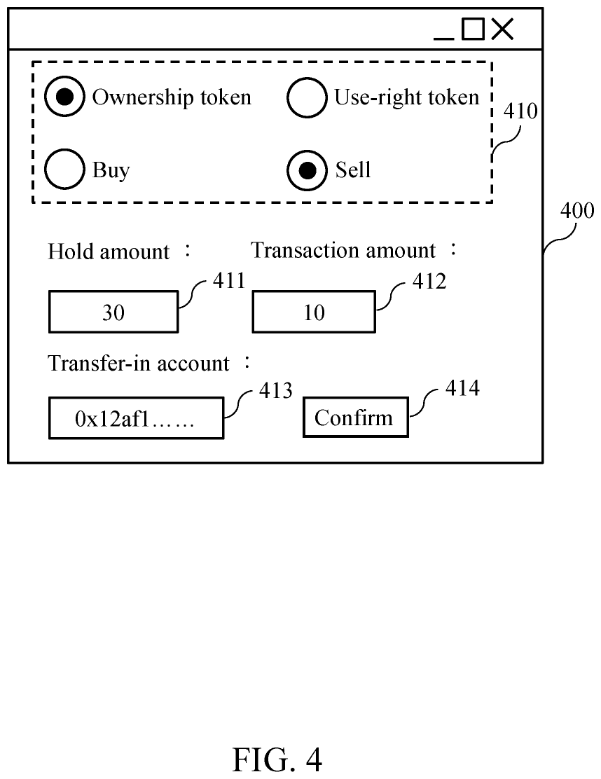

Some embodiments are described with reference to FIGS. 3A, 3B and 4. Please refer to FIGS. 3A and 3B, which are schematic views of right management system of the present invention applied to an artwork, software, real estate and vehicle. In an embodiment in which the asset is an artwork, the ownership issuing host 120 deploys an asset smart contract of the art work in the blockchain network 100, and the asset smart contract is used to manage the right of the artwork such as the ownership and the use right, and includes at least one owner account and ownership-ratio information corresponding to the at least one owner account. The ownership-ratio information can record an ownership ratio, for example, the ownership ratio can be preset by an author of the artwork and a sponsor; or multiple purchasers club to purchase and hold the artwork together, and the ownership ratio is set based on a funded ratio. In actual implementation, the ownership issuing host 120 displays a setting window 300, as shown in FIG. 3A, to provide the owner to input the at least one owner account in the input block 311 and input the ownership-ratio information in the input block 312. When there are multiple owners, the user can click an add component 313 to add an owner account and ownership-ratio information thereof. After all of the setting operations are completed, the user can click a determination component 314, the ownership issuing host 120 executes a token generating function of the asset smart contract to generate at least one corresponding and fungible ownership token representing the ownership of the artwork based on the ownership-ratio information, and transmit the corresponding amount of the ownership tokens to the corresponding owner account. In this example, the ownership-ratio information is 2/100, the token generating function generates 100 ownership tokens, and transmits two of the 100 ownership tokens to the corresponding owner account “0x06012c . . . ”.

Next, the owner, who owns the owner account, can provide a use-right issuing request through the asset smart contract; the use-right issuing request can include at least one relevant parameter such as the number of issued use rights, a serial number or usage time range of each use right. In actual implementation, the use-right issuing host 130 can generate the use right issue window 350, as shown in FIG. 3B, to provide the owner to input aforementioned relevant parameters into the input blocks (351˜353), respectively, and input the use-right transfer condition in the input block 354; for example, the purchaser must pay a certain amount of digital currency (such as 2 ETH) to the asset smart contract to obtain the use-right token representing the use right. Next, after the send component 355 is clicked, the aforementioned setting data is used as the parameters of the use-right issuing request and transmitted to other owner or attorney, to request approval of issuing the use right. When the use-right issuing request is approved by more than half of the owners, or by the authorized attorney, the use-right issuing function of the asset smart contract is executed to generate the non-fungible use-right token based on the ownership token; when the approval of setting the use-right transfer condition is obtained, the asset smart contract uses the received digital currency as the proceeds, and transfer the use-right token to the buyer account from the asset smart contract, and set the user information to the buyer account. Through above-mentioned operations, the transfer of the right to use the artwork can be completed, and the right can be leased or sold by asset smart contract at a preset price. Next, the asset smart contract calculates the profit-sharing amount of each of the at least one owner account based on the obtained digital currency, the proceeds and the ownership-ratio information, and transfers the digital currency, which is equivalent to the corresponding profit-sharing amount, to the corresponding owner account. As a result, the profit-sharing of each owner is completed. In an embodiment, in order to check whether the user has the right to use the artwork, the user's identity information can be transmitted to the authentication-side host 140, the authentication-side host 140 checks whether the identity information exists in the user information of the use-right token, and if the identity information exists in the user information of the use-right token, it represents that the user has the right to use the artwork; otherwise, it represents that the user does not have the right to use the artwork, and there may be concerns that the artwork has been stolen or misappropriated.

In an embodiment, the asset can be software and the overall process is much the same as that of the artwork, but the initial owner may be a software developer, a software issuing platform, or crowdfunders of a software development project, and the generated ownership token represents the ownership of the software, the generated use-right token represents the right to use the software; that is, the conventional software key is replaced by the use-right token, and obtaining the use-right token represents obtaining the right to use the software. The input block 351 shown in FIG. 3B can be regarded as a block to set a software serial number, and the input block 353 shown in FIG. 3B can be regarded as a block to set a period of using the software. Similarly, when the asset is real estate, the overall process is also much the same as the above-mentioned process, and the initial owner may be a real estate holder or a lending bank, and the generated ownership token represents the ownership of the real estate, the generated use-right token represents the right to use the real estate. In fact, the use-right token serves as a lease contract of the real estate, and obtaining the use-right token represents obtaining the right to use the real estate; at this time, the input block 351 shown in FIG. 3B can be regarded as a block to set a house or room number, and the input block 353 can be regarded as a block to set a lease term.

When the asset is a vehicle such as a bicycle, a car or a motorcycle, the overall process is similar to the above-mentioned processes of artwork, software and real estate. In other words, any asset of which ownership and use right can be managed does not depart from the application field of the present invention. Multiple vehicles are taken as an example of the asset, multiple purchasers can club to purchase the multiple vehicles to provide rental services, for example, the multiple purchases club to set up a vehicle rental company. In this example, the vehicles are the asset and owned by a plurality of funders, and each funder owns a part of the ownership of each vehicle. In application of the present invention, each vehicle has an asset smart contract corresponding thereto, and the asset smart contract is permitted to execute to generate the corresponding and non-fungible use-right token, so as to issue the right to use the vehicle, or transact the fungible ownership token to sell the ownership of the vehicle. In actual implementation, the right to use each vehicle can be checked by linking to the blockchain network through an internet of things (IoT) mechanism, for example, it checks if the use-right token exists, if yes, the vehicle is permitted to use; otherwise, the vehicle is not permitted to use. The rental income of each vehicle can be distributed based on the holding ratio of the ownership tokens of the vehicle, that is, the profit can be shared to the funders.

Please refer to FIG. 4, which is a schematic view of transaction of an ownership token and a use-right token of the present invention. In actual implementation, the transfer of the ownership and use right of the asset can be implemented by transaction of the ownership token or the use-right token through blockchain transaction. For example, in the case of selling ownership of a target, the user can select the target, which is to be transacted and may be ownership tokens, and a transaction manner (such as sell) through the selection component 410 of the transaction window 400; next, the user can know the current holding amount of the target displayed on the display block 411, and then input the transaction amount in the input block 412 and input a transfer-in account in the input block 413. After confirming the inputted data, the user can click the confirm component 414 to start transaction, in this example, 10 ownership tokens of 30 ownership tokens are sold, and the 10 ownership tokens are transferred to the transfer-in account. In this way, the transfer-in account can hold the ownership token, and the person owning the transfer-in account also has the identity of owner. Furthermore, in the case of purchasing the use right, the purchaser can select the target (such as the use-right tokens) to be transacted, in the selection component 410, and the transaction manner (such as purchase); next, the purchaser also can input the transaction amount in the input block 412 and input the account, to which the purchased ownership token is transferred, in the input block 413. After confirming the inputted date, the purchaser clicks the confirm component 414 to start transaction. In this way, the account inputted in the input block 413 can obtain the use-right token; next, when the asset is to be used, the authentication-side host 140 (such as an IoT device) can authenticate whether the account holds the use-right token, so as to confirm whether the account owns the right to use the asset. It is to particularly note that the price of the digital currency recorded in the use-right transfer condition can be changed during the transaction process; for example, when transaction of the use-right token is hot, the digital currency price recorded in the use-right transfer condition can be increased, in contrast, the price can be decreased. Furthermore, the transaction price of the ownership token can be adjusted along with the change of the transaction price of the use-right token, for example, when the transaction price of the use-right token is increased, the transaction price of the ownership token corresponding to the use-right token can also be increased; in contrast, the price can be decreased. In this way, the person who wants to pay the price to use the asset (that is, obtain the right to use the asset) can observe the transaction condition of the ownership token to know the public evaluation value of the asset in advance; when more users want to pay the price to obtain the right to use the asset, it represents the value of the ownership of the asset is higher.

According to above-mentioned contents, the difference between the present invention and the conventional technology is that the asset smart contract of the asset can be pre-deployed on the blockchain network, and the asset smart contract is executed to generate the fungible ownership token representing the ownership of the asset and generate the non-fungible use-right token representing the right to use the asset based on the ownership token, and when the asset smart contract receives the proceeds obtained through the transaction of the use-right token, the asset smart contract can transfer the use-right token, and calculate and transmit the profit-sharing amount to the owner. The technical solution of the present invention can solve the conventional technology problem, and achieve the technical effect of improving convenience in rights management and income of the asset.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An asset right management system based on blockchain, wherein the asset right management system is applied to the blockchain network which is formed by a plurality of node hosts, each of the node hosts has a wallet address as node identification and has the ability to access a blockchain wallet according to the wallet address, and the asset right management system comprises:
an ownership issuing host being one of the plurality of node hosts and comprising:
a first computer readable storage device configured to store a plurality of first computer instructions; and
a first hardware processor coupled to the first computer readable storage device, the first hardware processor configured to execute the first computer instructions to:
pre-deploy an asset smart contract of an asset in a blockchain network in initial, wherein the asset smart contract comprises at least one owner account and ownership-ratio information corresponding to the at least one owner account; and
execute a token generating function of the asset smart contract, wherein the token generating function generates at least one fungible ownership token based on the ownership-ratio information; and
a use-right issuing host being one of the plurality of node hosts and having one of the at least one owner account, and comprising:
a second computer readable storage device configured to store a plurality of second computer instructions; and
a second hardware processor coupled to the second computer readable storage device, the second hardware processor configured to execute the second computer instructions to:
execute a use-right issuing function of the asset smart contract, wherein the use-right issuing function transmits a use-right issuing request to request an owner to approve issue of a right to use the asset;
perform the use-right issuing function after the use-right issuing request is approved to generate at least one non-fungible use-right token based on the ownership token and permit to set a use-right transfer condition of the at least one use-right token, and request the owner to approve the use-right transfer condition, wherein the use-right token comprises user information;
permit the asset smart contract to receive digital currency as proceeds after the use-right transfer condition is approved, and to transfer the use-right token from the asset smart contract to a buyer account and to set the user information to the buyer account; and
calculate a profit-sharing amount of each of the at least one owner account based on the proceeds and the ownership-ratio information, and transfer the digital currency, which are equivalent to all of the at least one profit-sharing amount, to the at least one owner account, respectively.

2. The asset right management system according to claim 1, further comprising an authentication-side host configured to receive identity information and detect whether the identity information exists in the user information of the use-right token, wherein when the identity information exists in the user information of the use-right token, the asset is permitted to be used or accessed, and when the identity information does not exist in the user information of the use-right token, the asset is prohibited from being used or accessed.

3. The asset right management system according to claim 1, wherein transmitting the use-right issuing request comprises transmitting the use-right issuing request to at least one of the at least one owner account and a preset attorney account, to request approval of issuing the right to use the asset.

4. The asset right management system according to claim 3, wherein the approval of the use-right issuing request comprises that the amount of the at least one owner account approving to issue the use right satisfies a threshold value, or approval information transmitted by the attorney account is received.

5. The asset right management system according to claim 1, wherein the token generating function is configured to detect a generation condition, and when the generation condition is satisfied, the token generating function is permitted to generate the ownership token, and the generated ownership token is transmitted to the at least one owner account based on the ownership-ratio information, respectively, and the ownership token is permitted to be transmitted to the buyer account from the at least one owner account through the blockchain transaction, and the token generating function updates the at least one owner account and the ownership-ratio information.

6. An asset right management method based on blockchain, wherein the asset right management method is applied to a blockchain network which is formed by a plurality of node hosts, each of the node hosts has a wallet address as node identification and has the ability to access a blockchain wallet according to the wallet address, and the asset right management method comprises:
pre-deploying, by an ownership issuing host which is one of the plurality of node hosts, an asset smart contract of an asset in the blockchain network, wherein the asset smart contract comprises at least one owner account and ownership-ratio information corresponding to the at least one owner account;
executing, by the ownership issuing host, a token generating function of the asset smart contract, to generate at least one fungible ownership token based on the ownership-ratio information;
using one of the plurality of node hosts which stores one of the at least one owner account, as a use-right issuing host, wherein when the use-right issuing host executes a use-right issuing function of the asset smart contract, and the use-right issuing function transmits a use-right issuing requests to request at least one owner to approve the issue of right to use the asset;
after approval of the use-right issuing request is obtained, performing a use-right issuing function to generate the at least one non-fungible use-right token based on the ownership token, permitting to set a use-right transfer condition of the use-right token, and requesting the at least one owner to approve the use-right transfer condition, wherein the use-right token comprises user information;
when an approval of setting the use-right transfer condition is obtained, permitting the asset smart contract to receive digital currency as proceeds, and the asset smart contract to transfer the use-right token to a buyer account from the asset smart contract and to set the user information to the buyer account; and
calculating a profit-sharing amount of each of the at least one owner account based on the proceeds and the ownership-ratio information, and transferring the digital currency equivalent to all of the at least one profit-sharing amount, to the at least one owner account, respectively.

7. The asset right management method according to claim 6, further comprising:
receiving identity information by an authentication-side host, and detecting whether the identity information exists in the user information of the use-right token;
when the identity information exists in the user information of the use-right token, permitting the asset to be used or accessed; and
when the identity information does not exist in the user information of the use-right token, prohibiting the asset from being used or accessed.

8. The asset right management method according to claim 6, wherein the step of transmitting the use-right issuing request comprises:
transmitting the use-right issuing request to all of the at least one owner account, or transmitting the use-right issuing request to a preset attorney account, to request approval of issuing the right to use the asset.

9. The asset right management method according to claim 8, wherein the approval of the use-right issuing request comprises that an amount of the at least one owner approving to issue the use right satisfies a threshold value, or approval information transmitted by the attorney account is received.

10. The asset right management method according to claim 6, wherein the token generating function detects a generation condition, and when the generation condition is satisfied, the token generating function is permitted to generate the ownership token, and transmit the generated ownership token to the at least one owner account based on the ownership-ratio information, and the ownership token is permitted to be transmitted to the buyer account from the at least one owner account through a blockchain transaction, and the at least one owner account and the ownership-ratio information are updated.
